(19) United States
(12) Patent Application Publication
(10) Pub. No.: US 2012/0166307 A1
(43) Pub. Date: Jun. 28, 2012

(54) DETERMINATION OF PERMISSIBILITY ASSOCIATED WITH E-COMMERCE TRANSACTIONS

(75) Inventor: Jianmin Pan, Hangzhou (CN)

(73) Assignee: ALIBABA GROUP HOLDING LIMITED, George Town (KY)

(21) Appl. No.: 13/330,400

(22) Filed: Dec. 19, 2011

(30) Foreign Application Priority Data
Dec. 23, 2010 (CN) 201010603488.9

(51) Int. Cl. G06Q 30/06

(52) U.S. Cl. 705/26.35

(57) ABSTRACT

Determining permissibility of a transaction includes: receiving new execution information associated with a transaction; determining specified characteristics in the new execution information; determining a plurality of similarity measures between the specified characteristics of the new execution information and specified characteristics of a set of stored execution information; selecting, based on the plurality of similarity measures, a set of similar execution information from the set of stored execution information; and determining permissibility associated with the new execution information based at least in part on computation that is based at least in part on permissible information and impermissible information of the set of similar execution information.

### CROSS REFERENCE TO OTHER APPLICATIONS

This application claims priority to People's Republic of China Patent Application No. 201010603488.9 entitled AN INFORMATION RECOGNITION METHOD AND DEVICE filed Dec. 23, 2010 which is incorporated herein by reference for all purposes.

### BACKGROUND OF THE INVENTION

Online shopping websites facilitate buyer-users to purchase products from seller-users. During a transaction, the buyer-user identifies a product to purchase, makes payment, and the seller-user uses logistics to ship the product to the buyer-user, etc. Servers of the e-commerce platform typically record each step of the shopping process and store the execution information obtained.

The virtual nature of the transactions can lead to certain problems. For example, some unscrupulous seller-user may pose as a buyer-user to purchase his/her own products, in order to elevate sales figures displayed to other users and cause false sales information to be displayed to buyer-users. The integrity of online shopping transactions is therefore compromised.

In order to preserve the integrity of online shopping transactions, many existing online shopping platforms employ statistical analysis to recognize impermissible information (such as information pertaining to illegal or otherwise unpermitted activities), and use such information to determine that an online shopping transaction is an impermissible operation. The typical statistical analysis technique has the following steps:

Step 1, a large volume of execution information is collected and impermissible execution information is identified manually.

Here, a piece of execution information can be considered to be all of the information related to the current shopping transaction recorded by the transaction server after a shopping transaction is executed.

Suppose that the execution information for a particular shopping transaction includes the characteristics of “name of product purchased, buyer-user payment method, and shipping method used by seller-user.” If the content of “shipping method used by seller-user” is blank, this indicates that the seller-user did not actually ship the products to the buyer-user; in this case, the seller-user can be considered to have purchased the product posing as a buyer, therefore, the execution information for this shopping transaction can be determined to be impermissible.

Step 2, specified characteristics contained in the execution information are set.

If every piece of execution information includes the three characteristics in the previous step, then the two characteristics of “buyer-user payment method” and “shipping method used by seller-user” can be set as the specified characteristics.

Step 3, whether each specified characteristic has manifested in permissible or impermissible execution information is analyzed and recorded.

Using the example characteristic of shipping method used by the seller-user, if the content is blank, the manifested execution information is impermissible; if the content is mail, express courier, or other appropriate delivery methods, the manifested execution information is permissible.

Step 4, the differences between impermissible execution information of the specified characteristics and permissible execution information are compared.

Step 5, when a new piece of execution information is generated (e.g., an online shopping transaction is being executed currently), the specified characteristics contained in the new execution information are extracted and compared against the permissible and impermissible manifestations of the characteristics, to form the basis for determining whether the execution information for the new shopping transaction is impermissible. The specific comparison process is as follows:

The manifestations of impermissible or permissible execution information for a specified characteristic are converted into two numerical values according to an established algorithm. If the converted numerical value of the manifestations of the specified characteristics exceeds a predefined threshold value, this indicates that the new execution information is impermissible information; otherwise, the new execution information is permissible information.

The statistical analysis-based impermissible information recognition technique described above uses the characteristics of impermissible/permissible information statistically analyzed in advance as the comparison benchmark to recognize whether new execution information is permissible; it is able to recognize a portion of impermissible information. In real situations, however, the characteristics of a massive volume of execution information have extremely complex manifestations. In the technique described above, permissible and impermissible information is distinguished based only on preset threshold values. This way, only execution information having common impermissible forms can be found, and the system is often unable to accurately recognize the permissibility of massive volumes of execution information.

### BRIEF DESCRIPTION OF THE DRAWINGS

Various embodiments of the invention are disclosed in the following detailed description and the accompanying drawings.

FIG. 1A is a system diagram illustrating an embodiment of a system for determining permissibility of activities performed by users.

FIG. 1B is a functional diagram illustrating a programmed computer system for identifying impermissible transactions in accordance with some embodiments.

FIG. 1C is a flowchart illustrating an embodiment of a process for determining the permissibility associated with the new execution information.

FIG. 2 is a flowchart illustrating an embodiment of a process for creating a database of execution information.

FIG. 3 is a flowchart illustrating an embodiment of a process for recognizing the permissibility associated with the new execution information.

FIG. 4 is a system diagram illustrating an embodiment of an information recognition device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

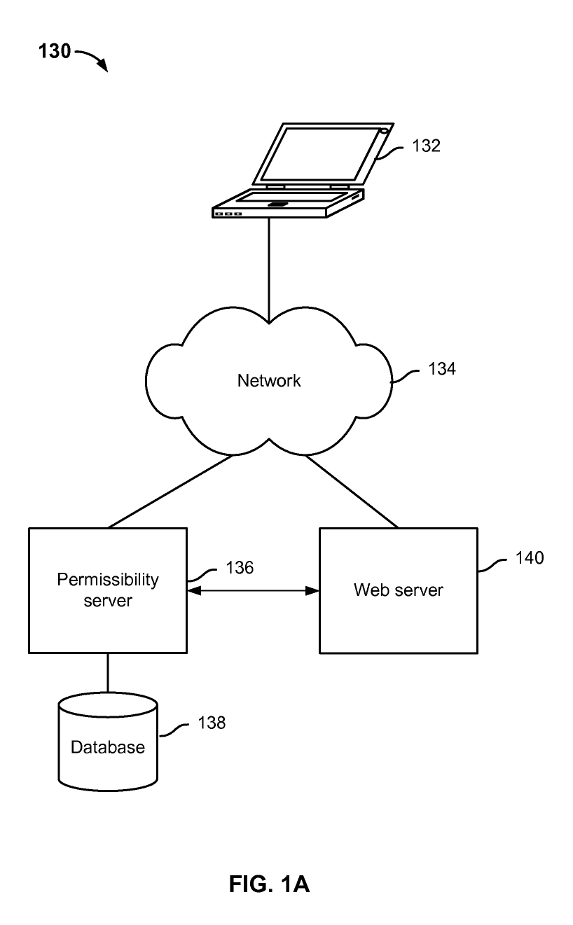

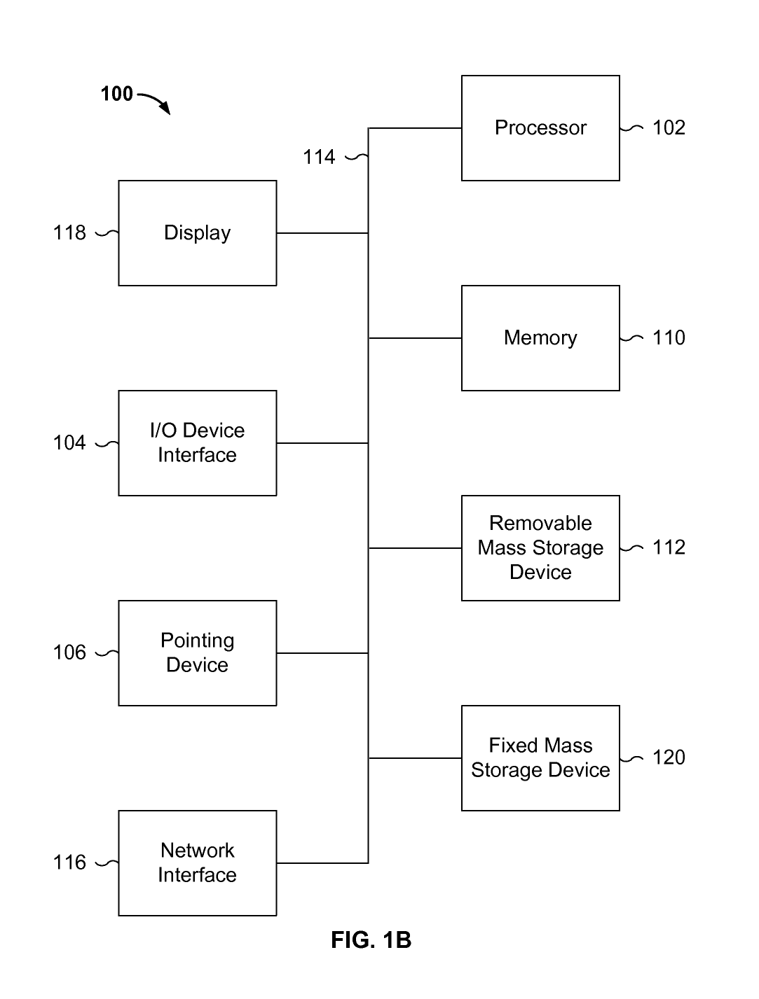

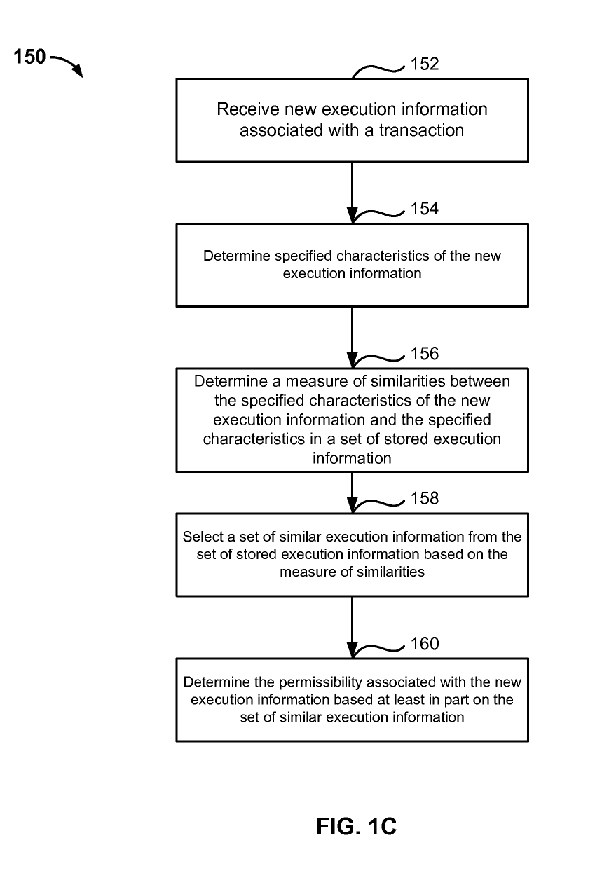

FIG. 1A is a system diagram illustrating an embodiment of a system for determining permissibility of activities performed by users. In this example, a database 138 that includes a large volume of impermissible execution information and permissible execution information is established. Users interact with web server 140 (e.g., an e-commerce server) over a network 134 (e.g., the Internet). The execution information pertaining to these interactions are sent to a permissibility recognition server 136. When the permissibility associated with the new execution information needs to be recognized, the execution information having relatively high similarity to the new execution information is determined from the database, and a determination is made as to the permissibility associated with the new execution information, based on whether the execution information determined from the database is permissible. Because the technique determines the permissibility associated with the new execution information to be recognized based on multiple pieces of execution information having relatively high similarities, the characteristics of the permissible execution information and impermissible execution information selected are synthesized, enabling the permissibility of the recognized execution information to truly reflect the permissibility of the online shopping transaction expressed by the execution information, and raising the accuracy of execution information recognition.

The execution information involved in the embodiments of the present disclosure refers to the information related to a single shopping transaction that is recorded by the server in the course of the shopping transaction.

Characteristics of the execution information involved in the embodiments of the present disclosure refer to the various types of information contained in the execution information, wherein each type of information corresponds to one characteristic. For example, if the execution information contains several or all of the following six types of information: sex of seller, buyer's rating, purchase date, transaction volume, transaction price, and shipping method, then each type of information corresponds to one characteristic of the execution information.

The specified characteristics of execution information involved in each of the embodiments of the present disclosure refer to the characteristics contained in the execution information that are used to recognize the permissibility of the execution information; specified characteristics may be some or all of the characteristics.

Determination of the permissibility of execution information refers to the determination of whether execution information is permissible information or impermissible information.

Permissible execution information means that no abnormalities exist in the various types of information contained in the execution information; the online shopping transactions expressed by permissible execution information are permissible transactions. Impermissible execution information means that abnormal execution information appears or is very likely to appear in the various types of information contained in the execution information; online shopping transactions expressed by impermissible execution information are impermissible transactions, such as false transactions in which a buyer-user purchases his/her own products.

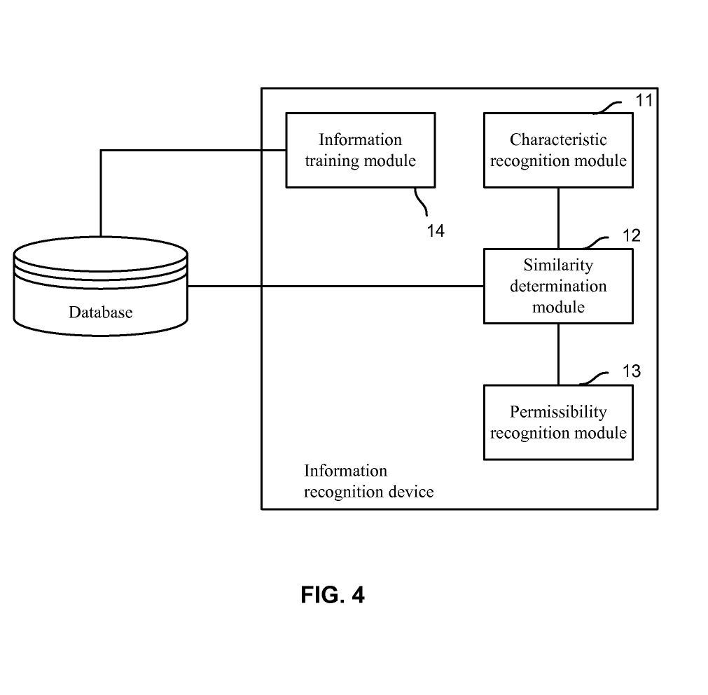

FIG. 1B is a functional diagram illustrating a programmed computer system for identifying impermissible transactions in accordance with some embodiments. As shown, FIG. 1B provides a functional diagram of a general purpose computer system programmed to perform identification of impermissible transactions in accordance with some embodiments. As will be apparent, other computer system architectures and configurations can be used to perform context-sensitive script editing for form design. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118). In some embodiments, processor 102 includes and/or is used to provide modules described below with respect to FIG. 4 and/or executes/performs the processes described below with respect to FIGS. 1B, 2 and 3.

Processor 102 is coupled bi-directionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions (e.g., programmed instructions). For example, memory/primary storage devices 110 can include any suitable computer readable storage media, described below, depending on whether, for example, data access needs to be bi-directional or uni-directional. For example, processor 102 can also directly and very rapidly retrieve and store frequently needed data in a cache memory (not shown).

A removable mass storage device 112 provides additional data storage capacity for the computer system 100 and is coupled either bi-directionally (read/write) or uni-directionally (read only) to processor 102. A fixed mass storage device 120 can also, for example, provide additional data storage capacity. For example, storage devices 112 and/or 120 can include computer readable media, such as magnetic tape, flash memory, PC-CARDS, portable mass storage devices such as hard disks, holographic storage devices, and other storage devices. Mass storages 112 and/or 120 generally store additional programming instructions, data, and the like that typically are not in active use by the processor 102. It will be appreciated that the information retained within mass storage 112 and 120 can be incorporated, if needed, in standard fashion as part of primary storage 110 (e.g., RAM) as virtual memory.

In addition to providing processor 102 access to storage subsystems, bus 114 can be used to provide access to other subsystems and devices as well. As shown, these can include a display 118, a network interface 116, an input/output (I/O) device interface 104, a sound card, speakers, as well as other subsystems as needed. For example, I/O device interface 104 can be a touchscreen, a voice recognition device, a keyboard, a pointing device, and/or any other appropriate device for interacting with system 100. An I/O device interface can be used in conjunction with computer system 100. The I/O device interface can include general and customized interfaces that allow the processor 102 to send and, more typically, receive data from other devices such as keyboards, pointing devices, microphones, touch-sensitive displays, transducer card readers, tape readers, voice or handwriting recognizers, biometrics readers, cameras, portable mass storage devices, and other computers.

The network interface 116 allows processor 102 to be coupled to another computer, computer network, or telecommunications network using a network connection as shown. For example, through the network interface 116, the processor 102 can receive information (e.g., data objects or program instructions) from another network, or output information to another network in the course of performing method/process steps. Information, often represented as a sequence of instructions to be executed on a processor can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

In addition, various embodiments disclosed herein further relate to computer storage products with a computer readable medium that includes program code for performing various computer-implemented operations. The computer readable medium is any data storage device that can store data which can thereafter be read by a computer system. Examples of computer readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 1A is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

FIG. 1C is a flowchart illustrating an embodiment of a process for determining the permissibility associated with the new execution information. Process 150 may be executed on a system such as 100 operating at an e-commerce website.

At 152, new execution information associated with a transaction is received. In some embodiments, when an online shopping transaction is executed (e.g., a purchase request is submitted), a log server at the e-commerce website will record the execution information for this online purchase, send the recorded execution information to the information recognition device, and request the information recognition device to determine the permissibility of the received new execution information.

At 154, specified characteristics of the new execution information are determined. In some embodiments, the specified characteristics include partial characteristics selected among the characteristics of the execution information based on empirical values. For example, if the four characteristics of {sex of seller, buyer rating, purchase date, transaction volume} are selected, after the information recognition device receives the new execution information to be recognized, it determines that the value of the four specified characteristics are {male, good, Sep. 29, 2010, 300}.

At 156, a measure of similarities between the specified characteristics of the new execution information and the specified characteristics of a set of stored execution information is determined.

In some embodiments, a database of execution information is maintained for the storage of a certain quantity of execution information, and the execution information stored in the database includes both permissible and impermissible information. The database can be independent from the information recognition device but able to communicate with the information recognition device, or it may be an internal database of the information recognition device.

As will be discussed more fully below, execution information in the database that is more similar to the new execution information is used to determine the permissibility associated with the new execution information. In some embodiments, to avoid substantial differences in the quantity of permissible information and the quantity of impermissible information contained in the database, which could lead to substantial differences in the weightings for each piece of similar execution information, the quantity of permissible information and the quantity of impermissible information stored in the database are roughly equivalent. In some embodiments, the difference between the quantity of permissible information and the quantity of impermissible information is set to be less than N (N being a positive integer), or the ratio of the quantity of impermissible information to the quantity of permissible information is maintained at 0.9-1.1.

In some embodiments, the information recognition device performs similarity computations with respect to each piece of execution information included in the database and the new execution information, to obtain the similarity measure between each piece of execution information contained in the database and the execution information to be recognized.

In some embodiments, the similarity measure corresponds to the distance between execution information in multidimensional space, after the multidimensional specified characteristics of each piece of execution information have been mapped to the multidimensional space. The greater the distance between two pieces of execution information, the lower the degree of similarity indicated between these two pieces of execution information.

At 158, a set of similar execution information is selected from the set of stored execution information based on the measure of similarities. In some embodiments, based on the similarity measures, M pieces of execution information having the highest similarity to the new execution information are selected, where M is a positive integer greater than 0. The value of M can be selected based on the specified characteristics of execution information contained in the database, in order to avoid the problem of inaccuracy due to over or under valuation of M. For example, in particular, if the value of M is too small, e.g., M=1, it means that the permissibility of the execution information to be recognized will be determined by the most similar piece of execution information. In this situation, if the most similar piece of execution information chosen is insignificant information or information for which there was an error in the selection process, it can result in inaccuracy of the determination of the permissibility of the execution information to be recognized. On the other hand, if the value of M is too great, e.g., M=50, it means that the permissibility of the execution information to be recognized will be determined jointly by the 50 most similar pieces of execution information, which could result in the following situation: of the 50 pieces of most similar execution information, 15 pieces of execution information having the highest similarity to the execution information to be recognized are impermissible information, while the remaining 35 pieces of execution information with the second highest similarity are permissible information. Thus, because the quantity of permissible information is greater, the final determination result is that the execution information to be recognized is permissible. But in fact, the new execution information is most similar to the 15 pieces of impermissible information and the true status of the new execution information should be impermissible information. The determination made in this case is therefore incorrect. In some embodiments, M is set to 9 or a value between 7-11.

At 160, the permissibility associated with the new execution information is determined based at least in part on computations based on the impermissible information and the permissible information stored in the selected set of similar execution information having the highest similarity to the new execution information.

A number of ways to determine the permissibility associated with the new execution information are possible. Two examples are described herein.

In some embodiments, when M is an odd number, the greater of the quantity of impermissible information and the quantity of permissible information contained in the M pieces of execution information is determined, and the permissibility associated with the new execution information is recognized as being the same as that of the information corresponding to the greater quantity. For example, if M=11, and the quantity of impermissible execution information is 7 and the quantity of permissible execution information is 4, then, because in the majority of situations the new execution information more nearly approximates impermissible execution information, the new execution information is determined to be impermissible information.

In some embodiments, weighted values are computed according to the principle that the higher the similarity to the new execution information, the greater the corresponding weighted value. Details of how to compute the weighted values are described below. Weighted values corresponding to the M pieces of execution information having the highest similarity are determined separately. The weighted values for the impermissible information contained in the M pieces of execution information are summed to obtain a weighted sum of impermissible information, and the weighted values for the permissible information are summed to obtain a weighted sum of permissible information. The permissibility of the described new execution information is recognized to be the same as that of the information corresponding to the greater of the weighted sums.

For example, if M=11, and the quantity of impermissible information is 7 and the quantity of permissible information is 4, the weighted summation operation is performed on the 7 pieces of impermissible information in accordance with their respective weighted values, and the weighted summation operation is performed on the 4 pieces of permissible information in accordance with their respective weighted values; if the weighted sum for impermissible information is 8 and the weighted sum for permissible information is 5, then the new execution information is determined to be impermissible information.

Further, considering that the proportion of impermissible transactions in actual online shopping transactions is not great, and that once the new execution information is determined to be impermissible, restrictive measures will be adopted with respect to the online shopping transaction associated with the execution information, in order to avoid misidentification of permissible information as impermissible information. Some embodiments require a value representing the impermissible information to exceed a value representing the permissible information by a threshold amount. For example, after determining the quantity of permissible information and the quantity of impermissible information, or after determining the weighted sum for impermissible information and the weighted sum for permissible information, the greater of the values obtained is selected. If the type of information corresponding to the greater value is impermissible information, then the new execution information is only determined to be impermissible if the difference between the greater value and the lesser value exceeds a preset threshold value; otherwise, the new execution information is determined to be permissible information.

Compared to existing techniques of setting characteristic threshold values, using the techniques described above in connection with FIGS. 1A-1B to perform similarity operations with respect to the specified characteristics of the new execution information and known execution information contained in the database, and using the known execution information having a higher similarity measure to determine the permissibility associated with the new execution information effectively raises the accuracy of permissibility determination. Further, because the quantities of permissible execution information and impermissible execution information stored in the database are roughly the same, it overcomes the problem of substantial differences in the quantities of permissible information and impermissible information available for selection when high similarity is determined. This arises from substantial differences in the quantities of reference permissible information and impermissible information, thus enabling the execution information having high similarity that is ultimately selected to correctly reflect the permissibility associated with the new execution information.

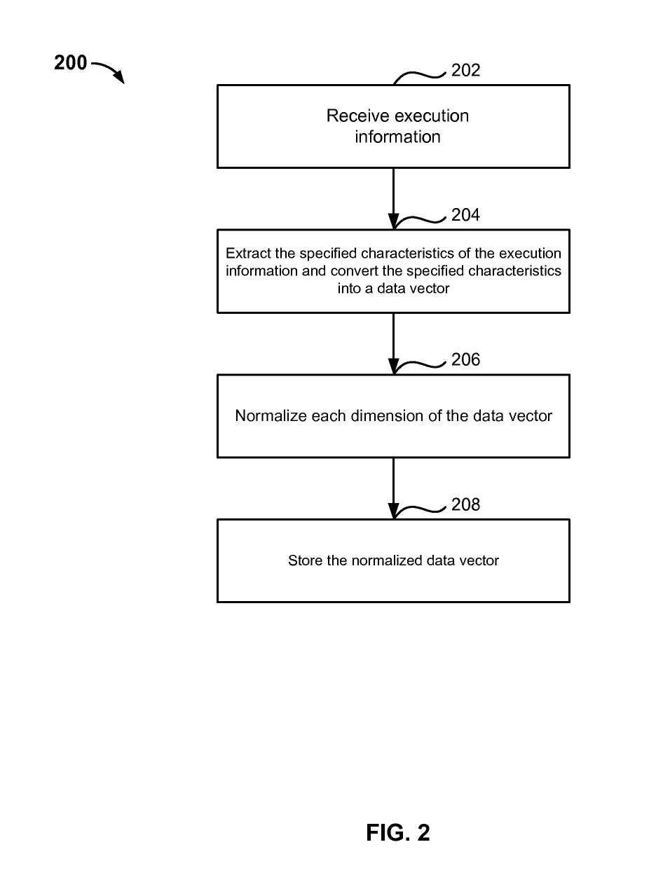

FIG. 2 is a flowchart illustrating an embodiment of a process for creating a database of execution information. The process may be performed on a system such as 100. Suppose that these four specified characteristics are used: {sex of seller, buyer rating, purchase date, transaction volume}.

At 202, execution information associated with a number of transactions is received. The execution information can be raw data recorded by the server each time an online shopping transaction is executed within a period of time (e.g., 3 months). Execution information recorded by the server includes permissibility status (e.g., permissible information and impermissible information associated with the transaction). In some embodiments, before information is written to the database, permissible information and impermissible information is determined (manually or otherwise), and the determination results can be coded in the execution information. The execution information used to train and write to the database is selected from the execution information having coded results.

Suppose that in this step, 200 pieces of permissible information and 200 pieces of impermissible information are received.

At 204, for each piece of execution information in the database, the specified characteristics of the execution information are extracted, and the specified characteristics are converted into a data vector.

For example, for a piece of execution information contained in the database, suppose that the online shopping transaction corresponding to the execution information comprises the following: the buyer-user purchases products from a male seller-user; the creation time of this online shopping transaction is Sep. 29, 2010; the transaction volume of this online shopping transaction is 300 units; and the buyer-user's rating of this online shopping transaction is good. Then, in accordance with the established specified criteria of {sex of seller, buyer's rating, purchase date, transaction volume}, the specified characteristics for the execution information are converted into the following data vector: {male, good, Sep. 29, 2010, 300}. Each dimension of the data vector corresponds to a relevant specified characteristic, and each piece of execution information that is converted into data vector form represents the specified characteristics of the execution information, thus reducing the volume of data stored in the database. Consequently, the similarity between the data vector of the new execution information and the data vectors of execution information already stored in the database can serve as the similarity between execution information.

At 206, to further facilitate the subsequent similarity computation process, each dimension of the data vector is optionally normalized. In other words, the content of each dimension is converted into a numerical value between 0-1. For example, the numerical value corresponding to male is 1, and the numerical value corresponding to female is 0. Buyer's ratings include the three ratings of “good,” “average,” and “poor,” corresponding to numerical values of 1, 0.5 and 0. The numerical value corresponding to the purchase date is determined based on the difference between the purchase data and an established date. In some embodiments, the greater the difference, the greater the numerical value corresponding to the purchase date; in other embodiments, the greater the difference, the smaller the numerical value corresponding to the purchase date. The corresponding relationships between transaction volumes and numerical values are demarcated in advance, and the corresponding numerical value is determined based on the number of transactions contained in the data vector. For example, if the transaction volume is 0, the corresponding numerical value is 0; if the transaction volume is 1-10, the corresponding numerical value is 0.1; if the transaction volume is 11-300, the corresponding numerical value is 0.2; and so on. For example, if a certain data vector is {male, good, Sep. 29, 2010, 300}, after normalization, it is converted to {1, 1, 0.1, 0.2}.

Once the normalized data vectors are stored in the database, at 208, the execution information stored in the database can be used to perform permissibility judgments with respect to the new execution information.

Although the content of the database is arranged in advance in the example shown, in some embodiments, after each determination of the permissibility associated with the new execution information, the normalized vector of the new execution information is also stored in the database (208). Using real-time updates to database contents allows the execution information used as determination criteria to be kept up to date and compatible with the inexhaustible variety of online shopping transactions.

Additionally, there is the potential for misjudgments to occur in the permissibility determinations of new execution information, such as when a certain piece of execution information is determined to be impermissible information, but the buyer-user or seller-user who executed the corresponding online shopping transaction disputes the determination and/or complains to the administrator. When it is determined that a misjudgment has occurred regarding the permissibility of a particular piece of execution information, the specified characteristic that has been misjudged can be updated based on the misjudged execution information (not shown in the flowchart), effectively perfecting the set-specified characteristics, and enabling the set-specified criteria to better reflect permissible information and impermissible information.

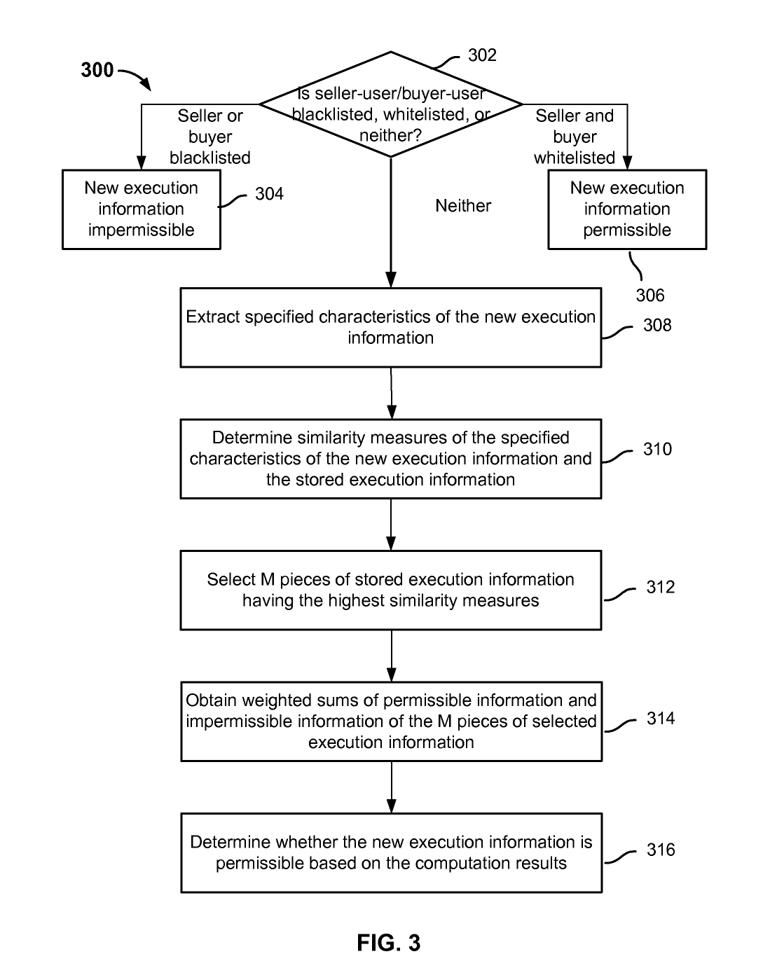

Upon completion of the building of the database, the database can be used to recognize the permissibility associated with the new execution information. FIG. 3 is a flowchart illustrating an embodiment of a process for recognizing the permissibility associated with the new execution information. In this example, users who have conducted a certain number of impermissible transactions (as determined by customer complaints, etc.) are blacklisted, users who have conducted many transactions but have never done anything impermissible are whitelisted, and the rest of the users are neither blacklisted nor whitelisted. The permissibility associated with the new execution information is therefore determined according to the black (or white) list.

At 302, it is determined whether the seller-user or the buyer-user is blacklisted, whitelisted, or neither.

If the seller-user or the buyer-user associated with the execution information is a blacklisted user, then, at 304, the new execution information is determined to be impermissible information.

If the seller-user and the buyer-user associated with the execution information are whitelisted users, then, at 306, the new execution information is determined to be permissible information.

If neither user is blacklisted and the users are both not whitelisted, at 308, the specified characteristics of the new execution information are extracted.

Suppose the data vector obtained through conversion of the specified characteristics of the new execution information is {female, average, Sep. 29, 2010, 300}, which, after normalization, becomes {0, 0.5, 0.1, 0.2}.

At 310, based on the normalized data vector of the new execution information and normalized data vectors in the database, the similarity measures of the specified characteristics of the new execution information and the specified characteristics of each piece of execution information stored in the database are determined.

Suppose that the normalized data vector for the new execution information (referred to as execution information A) is {0, 0.5, 0.1, 0.2}, and the normalized data vector for a particular piece of execution information contained in the database (referred to as execution information B) is {1, 1, 0.1, 0.2}. The specific similarity computation process then includes the following:

First, the results of comparisons between each dimension contained in the two pieces of execution information are computed separately. A variety of techniques can be used. In some embodiments, the differences between the numerical values of each dimension are computed successively, and the differences obtained serve as the comparison results for the dimensions; specifically for execution information A and execution information B, the comparison results for each dimension obtained according to this computation method are {1, 0.5, 0, 0}. In some embodiments, for each dimension, formula (1) below is used to compute the comparison results for each dimension of execution information A and execution information B:

d(aᵢ,bᵢ)=|aᵢ−bᵢ|/max value₍ᵢ₎ (1)

where aᵢ expresses the numerical value of dimension i in the data vector for the new execution information; bᵢ expresses the numerical value of dimension i in the data vector of one piece of stored execution information; max value₍ᵢ₎ expresses the difference between the maximum value and the minimum value of dimension i; and d(aᵢ, bᵢ) expresses the comparison results for dimension i of the data vector for the new execution information and dimension i of the data vector for one piece of stored execution information.

The comparison results between each dimension of execution information A and execution information B obtained using the second computation method are {1, 0.5, 0, 0}.

Then, the sum of the comparison results for each dimension of the data vectors for execution information A and execution information B serves as the similarity of these two pieces of execution information.

The comparison results for each dimension of execution information A and execution information B obtained, based on the computation techniques described above, are {1, 0.5, 0, 0}. Thus, the similarity of execution information A and execution information B is 1.5.

Next, computations are performed in accordance with the methods in this step on every piece of execution information stored in the database to obtain the similarity measure of the new execution information and each piece of execution information in the database.

At 312, M pieces of stored execution information having the highest similarity measures are selected from the database.

At 314, the weighted sum of permissible information and the weighted sum of impermissible information of the M pieces of execution information are obtained.

At 316, whether the new execution information is permissible information is determined based on the computation results.

In some embodiments, a continuously smoothing weighting function is used to compute weighted values for each piece of execution information. The expression of the function is shown in formula (2) below:

$${w}_{j} = exp ( \frac{- {D ( A , {B}_{j} )}^{2}}{{K}_{w}^{2}} ) \qquad ( 2 )$$

where wⱼ expresses the weight of execution information piece j; D(A, Bⱼ) expresses the similarity between execution information piece j and the new execution information, and can be computed by using equation (1) in some embodiments ; and K_{w} expresses the balance factor. This embodiment uses

$${K}_{w} = \frac{range}{n} ,$$

where the range expresses the similarity between the execution information having the lowest similarity among the M pieces of execution information and the new execution information, and n is a fixed parameter, such as 16.

After obtaining weighted values for each piece of execution information using the computations in formula (2), weighted sums can be computed. Any appropriate weighted sum technique can be used. Two examples are given below.

In some embodiments, weighted sums of permissible information and impermissible information are computed in accordance with formula (3) below:

$$y = \frac{{\sum }_{j = 1}^{M} {w}_{j} {y}_{j}}{{\sum }_{j = 1}^{M} {w}_{j}} \qquad ( 3 )$$

where y expresses the weighted sum of permissible information and impermissible information; wⱼ expresses the weighting of the j-th piece of execution information, and yⱼ expresses whether the j-th piece of execution information is permissible information or impermissible information; if it is permissible information, yⱼ=1; otherwise, yⱼ=0.

The y obtained using formula (3) is a numerical value in the range of 0-1; the numerical value is compared to a set value to determine whether or not the new execution information is permissible. For example, the set value can be 0.7; if the computed y is not less than 0.7, then all together, the new execution information is closer to permissible information, and the new execution information is therefore permissible information.

In some embodiments, the weighted values of impermissible information in the M pieces of execution information are summed to obtain a weighted sum for impermissible information, and the weighted values of permissible information are summed to obtain a weighted sum of permissible information. The weighted sum formula used is as shown in formula (4) below:

$${z}_{1} = {\sum }_{k = 1}^{P} {w}_{k} {y}_{k} , {z}_{2} = {\sum }_{l = 1}^{M - P} {w}_{l} {y}_{l} \qquad ( 4 )$$

where P corresponds to the number of pieces of permissible information among the M pieces of execution information, z₁ expresses the weighted sum of permissible information, and z₂ expresses the weighted sum of impermissible information. wₖ expresses the weight of the k-th piece of permissible execution information, and wₗ expresses the weight of the l-th piece of impermissible execution information. yₖ and yₗ respectively express whether the k-th piece of execution information is permissible information or impermissible information, and whether the l-th piece of execution information is permissible information or impermissible information; if they are permissible information, yₖ=yₗ=1; otherwise, yₖ=yₗ=0.

Select the greater of z₁ and z₂; if z₁ is greater than z₂, then the new execution information is permissible information; if z₂ is greater than z₁, then the new execution information is impermissible information.

FIG. 4 is a system diagram illustrating an embodiment of an information recognition device. In the example shown, the device includes a characteristic recognition module 11, a similarity determination module 12, and a permissibility recognition module 13. Characteristic recognition module 11 is used to determine the specified characteristics contained in the new execution information. Similarity determination module 12 is used to determine the similarity between the specified characteristics of the new execution information and the specified characteristics of each piece of stored execution information. Permissibility recognition module 13 is used to recognize whether the described new execution information is impermissible information or permissible information, based on computed numerical values for the impermissible information and permissible information included in the M pieces of execution information having the highest similarity, the M being a positive integer.

The device further comprises an information training module 14, used to convert the specified characteristics in each piece of execution information stored in the database into data vectors, wherein each dimension of the data vectors corresponds to one specified characteristic. The similarity determination module 12 is used to convert the specified characteristics included in the new execution information into a data vector, and determine the similarity between the data vector for the new execution information and the data vectors for each piece of stored execution information.

Information training module 14 is also used to successively normalize the data vectors contained in each piece of execution information, to obtain numerical values for each dimension contained in the vectors. Similarity determination module 12 is used to normalize the data vector for the new execution information, to obtain numerical values for each dimension contained in the data vector, to compare the numerical values of each dimension of the data vector for the new execution information against the numerical values of each dimension of the data vectors in each piece of stored execution information, and, based on the comparison results, to determine the similarity between the specified characteristics contained in the new execution information and the specified characteristics contained in stored execution information.

Permissibility recognition module 13 is used, when M is an odd number, to determine the greater of the quantity of impermissible information and the quantity of permissible information contained in the M pieces of execution information having the highest similarity, and to determine that the permissibility associated with the new execution information is the same as that of the information corresponding to the greater quantity.

Permissibility recognition module 13 is also used to determine weighted values corresponding to the M pieces of execution information having the highest similarity, wherein the higher the similarity to the new execution information, the greater the corresponding weighted value, and to sum the weighted values for impermissible information contained in the M pieces of execution information to obtain a weighted sum of impermissible information, and sum the weighted values for permissible information to obtain a weighted sum of permissible information, and determine that the permissibility associated with the new execution information is the same as that of the information corresponding to the greater weighted sum.

The information recognition device shown in FIG. 4 is separate from the database. In some embodiments, the database may also be integrated into the information recognition device in this embodiment.

The information recognition device shown in this example can also be provided with functional modules capable of executing the processes described above.

The modules described above can be implemented as software components executing on one or more general purpose processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

A person skilled in the art should understand that the embodiments of the present application can be provided as methods, systems or computer software products. Therefore, the present disclosure can take the form of embodiments consisting entirely of hardware, embodiments consisting entirely of software, and embodiments which combine software and hardware. Moreover, the present disclosure can take the form of computer programs implemented on one or more computer-operable storage media (including but not limited to magnetic disk storage devices, CD-ROMs, and optical storage devices) containing computer program codes.

The present application is described with reference to flow charts and/or block diagrams based on methods, equipment (systems) and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer readable storage devices that can guide computers or other programmable data equipment, with the result that the commands stored on these computer readable devices give rise to products that include command devices. These command devices realize the functions designated in one or more processes in a flow chart and/or one or more blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving new execution information associated with a transaction;
determining specified characteristics in the new execution information;
determining a plurality of similarity measures between the specified characteristics of the new execution information and specified characteristics of a set of stored execution information;
selecting, based on the plurality of similarity measures, a set of similar execution information from the set of stored execution information; and
determining permissibility associated with the new execution information based at least in part on computation that is based at least in part on permissible information and impermissible information of the set of similar execution information.

2. The method of claim 1, wherein the set of stored execution information is formed at least by:
receiving a set of execution information associated with a plurality of transactions, the set is of execution information comprising permissibility status; and
extracting specified characteristics of the execution information for each piece of execution information in the database.

3. The method of claim 2, wherein forming the set of stored execution information further comprises:
converting the specified characteristics into a data vector;
normalizing the data vector; and
storing the data vector.

4. The method of claim 1, wherein:
selecting the set of similar execution information from the set of stored execution information includes selecting M pieces of stored execution information having the highest similarity measures; and
determining the permissibility associated with the new execution information includes obtaining one or more weighted sums of permissible information and impermissible information of the M pieces of execution information.

5. The method of claim 4, wherein:
the weighted sum y of permissible information and impermissible information of the M pieces of execution information is computed according to
$$y = \frac{{\sum }_{j = 1}^{M} {w}_{j} {y}_{j}}{{\sum }_{j = 1}^{M} {w}_{j}} ;$$
wherein
wⱼ corresponds to a weight of j-th piece of execution information; and
yⱼ corresponds to whether the j-th piece of execution information is permissible or impermissible.

6. The method of claim 5, wherein:
$${w}_{j} = exp ( \frac{- {D ( A , {B}_{j} )}^{2}}{{K}_{w}^{2}} ) ;$$
D(A, Bⱼ) expresses a similarity between the j-th piece of execution information Bⱼ and the new execution information A; and
K_{w} expresses the balance factor.

7. The method of claim 4, wherein:
the weighted sum of permissible information z₁ and the weighted sum of impermissible information z₂ of the M pieces of execution information is computed according to:
$${z}_{1} = {\sum }_{k = 1}^{P} {w}_{k} {y}_{k} , {z}_{2} = {\sum }_{l = 1}^{M - P} {w}_{l} {y}_{l} ;$$
P corresponds to the number of pieces of permissible information;
wₖ corresponds to a weight of the k-th piece of permissible execution information; and
wₗ corresponds to a weight of the l-th piece of impermissible execution information.

8. The method of claim 1, wherein determining permissibility associated with the new execution information includes:
determining whether a seller-user associated with the transaction is blacklisted, whitelisted, or neither; and
determining whether a buyer-user associated with the transaction is blacklisted, whitelisted, or neither.

9. The method of claim 8, in the event that the seller-user or the buyer-user is blacklisted, the new execution information is deemed to be impermissible; and
in the event that the seller-user and the buyer-user are whitelisted, the new execution information is deemed to be permissible.

10. The method of claim 8, in the event that neither the seller-user nor the buyer-user is blacklisted, and the seller-user and the buyer-user are not both whitelisted, the method further comprises:
determining similarity measures of specified characteristics of the new execution information and specified characteristics of stored execution information;
selecting M pieces of stored execution information having the highest similarity measures;
determining weighted sums of permissible information and impermissible information of the M pieces of selected execution information; and
determining whether the new execution information is permissible based at least in part is on the weighted sums.

11. A system comprising:
one or more processors configured to:
receive new execution information associated with a transaction;
determine specified characteristics in the new execution information;
determine a plurality of similarity measures between the specified characteristics of the new execution information and specified characteristics of a set of stored execution information;
select, based on the plurality of similarity measures, a set of similar execution information from the set of stored execution information;
determine permissibility associated with the new execution information based at least in part on computations that is based at least in part on permissible information and impermissible information of the set of similar execution information; and
one or more memories coupled to the one or more processors, configured to provide the one or more processors with instructions.

12. The system of claim 11, wherein the set of stored execution information is formed at least by:
receiving a set of execution information associated with a plurality of transactions, the set of execution information comprising permissibility status; and
extracting specified characteristics of the execution information for each piece of execution information in the database.

13. The system of claim 12, wherein forming the set of stored execution information further comprises:
converting the specified characteristics into a data vector;
normalizing the data vector; and
storing the data vector.

14. The system of claim 11, wherein:
selecting the set of similar execution information from the set of stored execution information includes selecting M pieces of stored execution information having the highest is similarity measures; and
determining the permissibility associated with the new execution information includes obtaining one or more weighted sums of permissible information and impermissible information of the M pieces of execution information.

15. The system of claim 14, wherein:
the weighted sum y of permissible information and impermissible information of the M pieces of execution information is computed according to
$$y = \frac{{\sum }_{j = 1}^{M} {w}_{j} {y}_{j}}{{\sum }_{j = 1}^{M} {w}_{j}} ;$$
wherein
wⱼ corresponds to a weight of j-th piece of execution information; and
yⱼ corresponds to whether the j-th piece of execution information is permissible or impermissible.

16. The system of claim 15, wherein:
$${w}_{j} = exp ( \frac{- {D ( A , {B}_{j} )}^{2}}{{K}_{w}^{2}} ) ;$$
D(A, Bⱼ) expresses a similarity between the j-th piece of execution information Bⱼ and the new execution information A; and
K_{w} expresses the balance factor.

17. The system of claim 14, wherein:
the weighted sum of permissible information z₁ and the weighted sum of impermissible information z₂ of the M pieces of execution information is computed according to:
$${z}_{1} = {\sum }_{k = 1}^{P} {w}_{k} {y}_{k} , {z}_{2} = {\sum }_{l = 1}^{M - P} {w}_{l} {y}_{l} ;$$
P corresponds to number of pieces of permissible information;
wₖ corresponds to a weight of the k-th piece of permissible execution information; and
wₗ corresponds to a weight of the l-th piece of impermissible execution information.

18. The system of claim 11, wherein determining permissibility associated with the new execution information includes:
determining whether a seller-user associated with the transaction is blacklisted, whitelisted, or neither; and
determining whether a buyer-user associated with the transaction is blacklisted, whitelisted, or neither.

19. The system of claim 18, in the event that the seller-user or the buyer-user is blacklisted, the new execution information is deemed to be impermissible; and
in the event that the seller-user and the buyer-user are whitelisted, the new execution information is deemed to be permissible.

20. The system of claim 18, in the event that neither the seller-user nor the buyer-user is blacklisted, and the seller-user and the buyer-user are not both whitelisted, the one or more processors are further configured to:
determine similarity measures of specified characteristics of the new execution information and specified characteristics of stored execution information;
select M pieces of stored execution information having the highest similarity measures;
determine weighted sums of permissible information and impermissible information of the M pieces of selected execution information; and
determine whether the new execution information is permissible based at least in part on the weighted sums.

21. A computer program product for determining permissibility of execution, the computer program product being embodied in a tangible computer readable storage medium and comprising computer instructions for:
receiving new execution information associated with a transaction;
determining specified characteristics in the new execution information;
determining a plurality of similarity measures between the specified characteristics of the new execution information and specified characteristics of a set of stored execution information;
selecting, based on the plurality of similarity measures, a set of similar execution information from the set of stored execution information; and
determining permissibility associated with the new execution information based at least is in part on computation that is based at least in part on permissible information and impermissible information of the set of similar execution information.
